(19) United States
(12) Patent Application Publication
(10) Pub. No.: US 2012/0050946 A1
(43) Pub. Date: Mar. 1, 2012

(54) Supercapacitor module

(75) Inventors: Seung Hyun Ra, Seongnam-si (KR); Bae Kyun Kim, Seongnam-si (KR); Young Hak Jeong, Gunpo-si (KR)

(73) Assignee: SAMSUNG ELECTRO-MECHANICS CO., LTD., Suwon (KR)

(21) Appl. No.: 13/137,546

(22) Filed: Aug. 24, 2011

(30) Foreign Application Priority Data
Aug. 27, 2010 (KR) 10-2010-0083375

(51) Int. Cl. H01G 9/155

(52) U.S. Cl. 361/502

(57) ABSTRACT

Provided is a supercapacitor. The supercapacitor includes an electrode cell including a first electrode and a second electrode stacked alternately with inserting a separator therebetween, a first terminal extended from a first surface and a second surface opposing to each other at the electrode cell, a second terminal extended from a third surface and a fourth surface opposing to each other at the electrode cell and a housing to seal the electrode cell.

### CROSS-REFERENCE TO RELATED APPLICATIONS

This application claims the benefit of Korean Patent Application No. 10-2010-0083375 filed with the Korea Intellectual Property Office on Aug. 27, 2010, the disclosure of which is incorporated herein by reference.

### BACKGROUND OF THE INVENTION

1. Field of the Invention

The present invention relates to a supercapacitor module, and more particularly, to a supercapacitor including a plurality of terminals extended from each side surface of electrode cells.

2. Description of the Related Art

Supercapacitors have been attracting attention as high quality energy sources in a renewable energy system that can be applied to electric vehicles, hybrid vehicles, fuel cell vehicles, heavy equipment, mobile electronic terminals, and so on.

Such supercapacitors may be classified into electrical double layer capacitors using an electrical double layer theory, and hybrid supercapacitors using electrochemical oxidation-reduction reaction. Here, while the supercapacitors are widely used in fields that require high-output energy characteristics, they have a smaller capacity than in secondary batteries. The hybrid supercapacitors have been widely researched as new alternatives to improve capacitive characteristics of the electrical double layer capacitors. In particular, a lithium ion capacitor (LIC) among the hybrid supercapacitors may have a storage capacity three to four times larger than that of the electrical double layer capacitors.

Such supercapacitors may include cathodes and anodes, which are alternately laminated, and separators disposed between the laminated cathodes and anodes to electrically separate the cathodes and anodes from each other.

Meanwhile, since the supercapacitors have high output characteristics and low energy storage characteristics, a supercapacitor module in which a plurality of supercapacitors are connected in series or parallel is used in a vehicle or heavy equipment.

At this time, while the supercapacitor module can improve energy storage characteristics by driving the plurality of supercapacitors, since heat generated during driving of the supercapacitor module is also abruptly increased, reliability or stability of the supercapacitor module may be decreased. Therefore, the number of the supercapacitors provided in the supercapacitor module and use environments of the supercapacitor module must be restricted.

For this reason, the supercapacitor module still needs a technique of effectively radiating heat generated during driving of the plurality of supercapacitors.

### SUMMARY OF THE INVENTION

The present invention has been invented in order to overcome the above-described problems generated in the supercapacitor module and it is, therefore, an object of the present invention to provide a supercapacitor capable of increasing the heat discharge effect by including a plurality of terminals extended from each side surface of the electrode cell.

In accordance with one aspect of the present invention to achieve the object, there is provided a supercapacitor including: an electrode cell including a first electrode and a second electrode stacked alternately with inserting a separator therebetween; a first terminal extended from a first surface and a second surface opposing to each other at the electrode cell; a second terminal extended from a third surface and a fourth surface opposing to each other at the electrode cell; and a housing to seal the electrode cell.

Herein, the housing can include an opening to insert electrolyte solution.

And also, the housing can include an opening to insert electrolyte solution and a sealing member to seal the opening.

And also, the housing can include an opening to insert electrolyte solution and an opening valve to open and close the opening.

And also, the first electrode includes a first collector and a first active material layer arranged on both surfaces of the first collector, respectively, and the first terminal can be formed by being extended to both sides of the first collector around the first active material layer.

And also, the second electrode includes a second collector and a second active material layer arranged on both surfaces of the second collector, respectively, and the second terminal can be formed by being extended to both sides of the second collector around the second active material layer.

And also, the first terminal may have the same width of the first electrode.

And also, the second terminal may have the same width of the second electrode.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view of a supercapacitor in accordance with a first embodiment of the present invention;

FIG. 2 is an assembled perspective view of a supercapacitor in accordance with the first embodiment of the present invention;

FIG. 3 is a cross-sectional view taken along line I-I′ shown in FIG. 2; and

FIG. 4 is an assembled perspective view of a supercapacitor in accordance with the second embodiment of the present invention.

### DETAILED DESCRIPTION OF THE PREFERABLE EMBODIMENTS

Hereinafter, embodiments of the present invention for a supercapacitor module will be described in detail with reference to the accompanying drawings. The following embodiments are provided as examples to fully convey the spirit of the invention to those skilled in the art.

Therefore, the present invention should not be construed as limited to the embodiments set forth herein and may be embodied in different forms. And, the size and the thickness of an apparatus may be overdrawn in the drawings for the convenience of explanation. The same components are represented by the same reference numerals hereinafter.

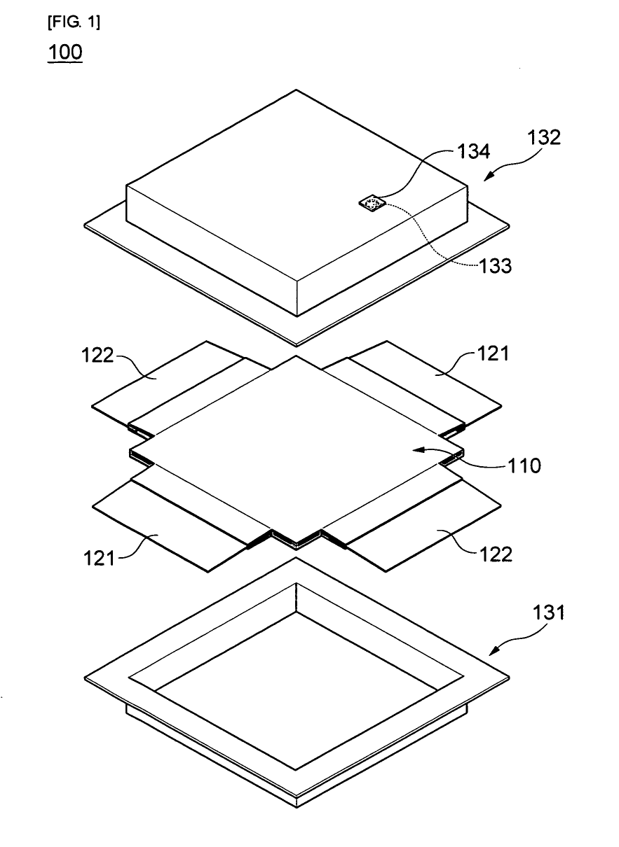

FIG. 1 is an exploded perspective view of a supercapacitor in accordance with a first embodiment of the present invention.

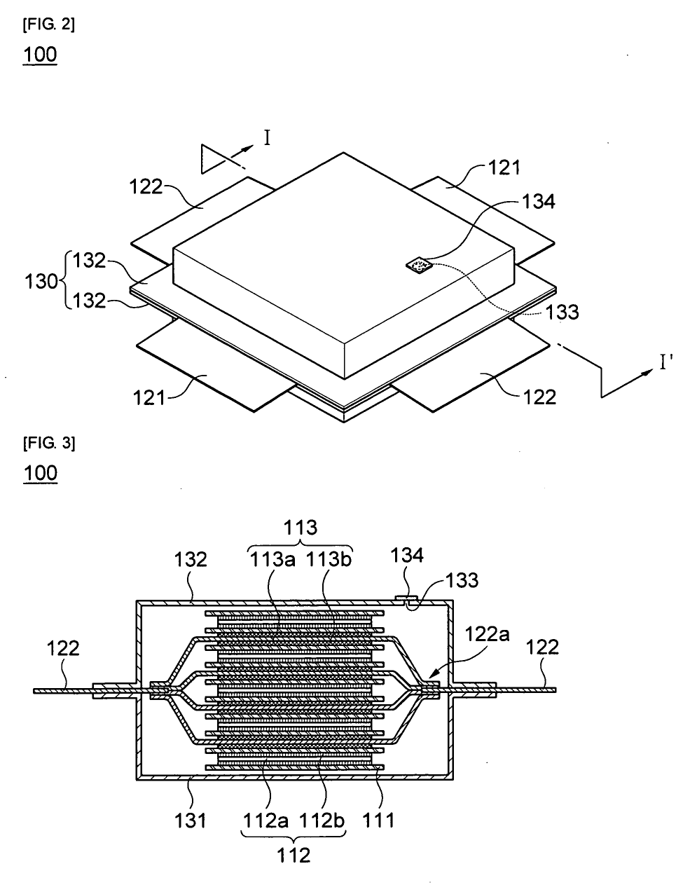

FIG. 2 is an assembled perspective view of a supercapacitor in accordance with the first embodiment of the present invention.

FIG. 3 is a cross-sectional view taken along line I-I′ shown in FIG. 2.

Referring to FIG. 1 to FIG. 3, the supercapacitor 100 in accordance with the first embodiment of the present invention may include an electrode cell 110, a first terminal 121, a second terminal 122 and a housing 130.

Herein, the supercapacitor 100 may be an electric double layer capacitor or a lithium-ion capacitor as an energy device to store electricity.

The electrode cell 110 can include a first electrode 112 and a second electrode 113 stacked alternately with spacing a separator 111 therebetween. Herein, the first and the second electrodes 112 and 113 can be stacked by crossing each other. Accordingly, the stacked first and second electrode 112 and 113 can be formed in the shape of cross.

The separator 111 can play a role of electrically separating the first and the second electrodes 112 and 113 from each other. Herein, the separator 111 may have an area larger than the first and the second electrodes 112 and 113 in order to electrically separate the stacked first and second electrodes 112 and 113 from each other. Accordingly, the separator 111 may have an area larger than the cross region between the first and the second electrodes 112 and 113.

The separator 111 can be made of an insulating material having durability to the electrolyte solution or the active material. And also, the separator 111 can have porous for moving ions. The exemplary materials for forming the separator 111 are cellulose, polyethylene and polypropylene. However, in the embodiments of the present invention, the material of the separator 111 is not limited.

The first and the second electrodes 112 and 113 are stacked by being alternately crossed with electrically separated by the separator 111.

The first electrode may be a cathode. At this time, the first electrode 112 can include the first collector 112b and a first active material layer 112a coated on both side surfaces of the first collector 112b.

The first collector 112b can include metal, e.g., any one among aluminum, titanium, tantalum and niobium. And also, the first collector 112b has a shape of thin film or can include a plurality of through holes to effectively perform the movement of ions. The first active material layer can include carbon material, e.g., charcoal, capable of absorbing/desorbing ions reversibly.

A first terminal 121 may be included in both sides of the first electrode 112 to be electrically connected to an external power.

The first terminal 121 may be connected to a first internal terminal 121a extended from both sides of the first collector 112b around the first active material layer 112a. At this time, the first terminal 121 and the first internal terminal 121a can be connected through welding and ultrasonic bonding. Herein, the first terminal 121 and the first internal terminal 121a may have the same width.

The first terminal 121 may be connected from the fist and the second surfaces opposing to the electrode cell, respectively. At this time, the first terminal 121 may be formed so as to have the same width of the first electrode 112. That is, the first terminal 121, the first internal terminal 121a and the first electrode 112 have the same width.

Although, in the embodiments of the present invention, it is explained that the supercapacitor includes the additional first terminal 121 in order to be connected to the external power, the present invention is not limited to this. For example, the terminal connected to the external power may be formed by being extended from the first collector 112b.

The second electrode 113 may be an anode. The second electrode 113 can include a second active material layer 113a coated on both surfaces of a second collector 113b.

The second collector 113b can include metal, e.g., any one among copper, nickel and stainless. And also, the second collector 113b has a shape of thin film or can include a plurality of through holes to effectively perform the movement of ions. The second active material layer can include carbon material, e.g., any one of graphite and charcoal, capable of absorbing/desorbing ions reversibly.

In addition, if the supercapacitor 100 is a lithium ion capacitor, the lithium ions may be coated on the second active material layer 113a previously.

A second terminal 122 may be included in both sides of the second electrode 113 to be electrically connected to an external power. Herein, the second terminal 122 may be connected to a second internal terminal 122a extended from both sides of the second collector 113b around the second active material layer 113a. Herein, the second internal terminal 122a and the second terminal 122 may have the same width. Although, in the embodiments of the present invention, it is explained that the supercapacitor includes the additional second terminal 122 in order to be connected to the external power, the present invention is not limited to this. For example, the terminal connected to the external power may be formed by being extended from the second collector 122b.

And also, the second terminal 122 may be formed by being extended from a third surface and a fourth surface opposing to the electrode cell 110 in order to be electrically separated from the first terminal 121.

Accordingly, since the electrode cell 110 can include the first and the second terminals 121 and 122 extended from four side surfaces, it can increase the heat discharge effect in comparison with the conventional electrode cell that two electrodes are drawn from both sides.

Also, since the first and the second terminals 121 and 122 have the same width of the first and the second electrodes 112 and 113, the contact resistance with the external power can be reduced by increasing the area to be contact with the external power in comparison with the terminal formed by extending a portion of the conventional electrode.

Although, in the embodiment of the present invention, it is explained that the first electrode 112 is a cathode and the second electrode 113 is an anode, the present invention is not limited to this; and, if the first electrode 112 is an anode, the second electrode 113 may be a cathode.

The supercapacitor 100 may further include the electrode cell 110, i.e., an electrolyte solution submerged into the separator 111, the first and the second electrodes 112 and 113.

The electrolyte solution may be made of a material capable of keeping ions stable without generating electrolysis under the high pressure as it plays a role of medium capable of moving the ions. Herein, the electrolyte solution can include electrolyte and solvent. The electrolyte may be a state of salt, e.g., lithium salt or ammonium salt. The examples of solvents may be propylene carbonate, diethylene carbonate, ethylene carbonate, sulfolane, acetonitrile, dimethoxyethene and trahydrofuran. However, in the embodiments of the present invention, the materials of electrolytes are not limited.

The housing 130 can seal the electrode cell 110 immerged into the electrolyte solution, i.e., the separator 111, the first and the second electrodes 112 and 113. Herein, the first and the second terminals 121 and 122 may be connected to the external power by being exposed to the housing 130. Accordingly, the supercapacitor can include the first and the second terminals 121 and 122 extended from the four side surfaces around the electrode cell 110. For example, the supercapacitor 100 may be the shape of cross.

The housing can include a first laminate film 131 and a second laminate film 132 arranged on a top and a bottom of the electrode cell 110. At this time, although the aluminum can be used as an example of material for forming the housing 130, in the embodiments of the present invention, the material or the shape of the housing 130 is not limited.

Herein, in order to assemble the electrode cell 110, at first the housing 130 can be formed by performing a thermal bonding according to the edges of the first and the second laminate films 131 and 132 joined with placing the electrode cell 110 therebetween. Herein, the thermal bonding can include a first thermal bonding process and a second thermal bonding process to be proceeded sequentially. Herein, the first thermal bonding process can be preceded according to the edges of the first and the second laminate films 131 and 132 except for a predetermined region, i.e., an insertion port. Thereafter, the second thermal bonding process may be a process of sealing the insertion port after the electrolyte solution is injected into the housing 130 through the insertion port. But, since the electrode cell 110 includes the first and the second terminals 121 and 122 in the four side surfaces, respectively, the first and the second terminals 121 and 122 may be contaminated by the electrolyte solution through the insertion port, i.e., the gaps of the first and the second laminate films 131 and 132.

In order to overcome this, openings 133 for inserting the electrolyte solution can be provided in the top surface or the bottom of the housing 130 to prevent the first and the second terminals 121 and 122 from being contaminated from the electrolyte solution. At this time, as the electrolyte solution is inserted through the openings 133 of the housing 130, the contamination of the first and the second terminals 121 and 122 can be prevented during the insertion process of the electrolyte solution.

In addition, the housing 130 can further include a sealing member 134 for sealing the openings 133. Herein, the sealing member 134 can play a role of protecting the openings 133 from the outside thereof after the insertion of electrolyte solution is finished. The sealing member 134 may be attached on the housing 130 so as to cover the openings 133 by a plastic sheet or a metal sheet, e.g., an aluminum sheet. At this time, the sealing member 134 can be attached on the housing 130 through a solder or an adhesive resin.

Accordingly, in the embodiments of the present invention, since the supercapacitor includes a plurality of terminals extended from each side surface and each terminal is formed at the same width of the electrodes, it can increase the heat discharge effect by increasing the area of region exposed to the outside thereof as well as can reduce the contact resistance with the external power.

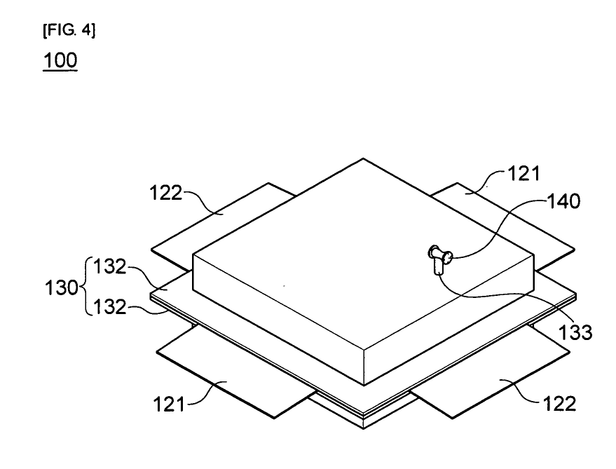

FIG. 4 is an assembled perspective view of a supercapacitor in accordance with the second embodiment of the present invention. Herein, since the second embodiment includes the technical construction equal to the first embodiment described above except for further including an open/close valve, the repeated explanation will be omitted.

Referring to FIG. 4, the supercapacitor in accordance with the second embodiment of the present invention includes an electrode cell 110, a first terminal 121, a second terminal 122 and a housing 130 for sealing the electrode cell 110.

Herein, the electrode cell 110 can include a fist electrode 112 and a second electrode 113 alternately stacked with placing a separator 111. Herein, the first and the second electrodes 112 and 113 can be stacked by crossing to each other in order to provide the first and the second terminals 121 and 122 in four side surfaces of the electrode cell 110.

The first terminal 121 can be connected to a first surface and a second surface opposing to each other at the electrode cell 110. And also, the first terminal 121 may have the same width of the first electrode 112.

The second terminal 122 can be connected to a third surface and a fourth surface opposing to each other in the electrode cell 110. Herein, the third surface can connect the first surface or the second surface; and the fourth surface opposing to the third surface can connect the first surface or the second surface. Accordingly, the second terminal 122 is provided in the other sides of the first terminal 121 and the electrode cell 110, thereby electrically separating the first terminal and the second terminal from each other. And also, the second terminal 122 may have the same width of the second electrode 113.

The housing 130 can seal the electrode cell 110 with exposing the first and the second terminals 121 and 122. Herein, the first and the second terminals 121 and 122 can include the openings 133 for inserting the electrolyte solution into the top or the bottom of the housing 130 in order to prevent from being contaminated from the electrolyte solution when the electrolyte solution is inserted into the housing 130.

In addition, the open/close valve 140 can be further included for opening and closing the openings 133. Herein, the electrolyte solution can be inserted into the housing 130 by opening the openings 133 using the open/close valve 140. After the insertion of the electrolyte solution is finished, the openings 133 of the housing 130 can be sealed from the outside through the open/close valve 140.

And also, the gas generated during the use of the supercapacitor 100 can be discharged to outside by opening the openings 133 through the open/close valve 140. Accordingly, the present invention can prevent the supercapacitor 100 from being deformed by the gas and prevent the stability from being deteriorated by the gas.

Therefore, in the embodiments of the present invention, the supercapacitor includes the openings for inserting the electrolyte solution into the housing and can prevent the first and the second terminals from being contaminated during the insertion of the electrolyte solution.

And also, since the super capacitor can discharge the gas of the supercapacitor at any time by including the open/close valve capable of controlling the open/close of the openings, the supercapacitor can be prevented from the deformation due to the gas and can prevent the stability from being deteriorated due to the gas.

The supercapacitor of the present invention can increase the heat discharge effect by providing a plurality of terminals extended from each side surface.

And also, each terminal of the supercapacitor in accordance with the present invention can further increase the heat discharge effect due to the increment of the region capable of being exposed to the outside thereof by being formed in the same width of the electrode.

And also, since the housing of the supercapacitor in accordance with the present invention includes the valve capable of opening/closing the housing, it can secure the stability of the supercapacitor by inserting the electrolyte solution as well as discharging the gas inside of the housing by providing the valve capable of opening and closing.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A supercapacitor comprising:
an electrode cell including a first electrode and a second electrode stacked alternately with inserting a separator therebetween;
a first terminal extended from a first surface and a second surface opposing to each other at the electrode cell;
a second terminal extended from a third surface and a fourth surface opposing to each other at the electrode cell; and
a housing to seal the electrode cell.

2. The supercapacitor according to claim 1, wherein the housing includes an opening to insert electrolyte solution.

3. The supercapacitor according to claim 1, wherein the housing includes an opening to insert electrolyte solution and a sealing member to seal the opening.

4. The supercapacitor according to claim 1, wherein the housing includes an opening to insert electrolyte solution and an opening valve to open and close the opening.

5. The supercapacitor according to claim 1, wherein the first electrode includes a first collector and a first active material layer arranged on both surfaces of the first collector, respectively, and
the first terminal is formed by being extended to both sides of the first collector around the first active material layer.

6. The supercapacitor according to claim 1, wherein the second electrode includes a second collector and a second active material layer arranged on both surfaces of the second collector, respectively, and
the second terminal is formed by being extended to both sides of the second collector around the second active material layer.

7. The supercapacitor according to claim 1, wherein the first terminal has the same width of the first electrode.

8. The supercapacitor according to claim 1, wherein the second terminal has the same width of the second electrode.
